(19) United States
(12) Patent Application Publication
(10) Pub. No.: US 2003/0235323 A1
(43) Pub. Date: Dec. 25, 2003

(54) Pre-embedded in-wall speaker seat

(76) Inventor: Pao-An Chuang, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/175,916

(22) Filed: Jun. 21, 2002

(51) Int. Cl. H04R 1/02

(52) U.S. Cl. 381/386

(57) ABSTRACT

A pre-embedded in-wall speaker seat comprising a frame of the speaker and a plurality of brackets, in which, by insertion of engaging hooks on the external peripheral surfaces of the middle sections of the brackets into engaging recesses to hook the inner edges of the engaging recesses, protrusions on these peripheral surfaces of the middle sections of the brackets can be inserted into some engaging grooves in passing to make engagement and positioning of some positioning ribs with some positioning recesses. Thereby, the pre-embedded in-wall speaker seat is completed. By engagement of the brackets with the engaging recesses of the frame, the frame can be fast connected with the brackets without a tool; and by connecting of the positioning ribs with the positioning recesses as well as the protrusions with the engaging grooves, the brackets can easily get a selection in alignment with the engaging grooves within the thickness of the wall to accomplish engagement and positioning by connections of relieves and recesses.

### BACKGROUND OF THE INVENTION

1. Field of the Invention

The present invention is related to a pre-embedded in-wall speaker seat, and especially to an in-wall speaker seat allowing a frame of the speaker to fast connect with a plurality of brackets without a tool but only by engagement of engaging hooks with engaging recesses, this structure can speed up the assembling work, and is particularly suitable for a pre-embedded structure such as a speaker seat or the like in a wall.

2. Description of the Prior Art

Referring to FIGS. 1a-1c, a conventional pre-embedded in-wall speaker seat is comprised mainly of a frame and three kinds of connecting brackets. The frame is a rectangular frame, and is provided on the surface thereof with indents and screw holes for positioning and screw connecting; the frame is provided on the walls thereof integrally with a plurality of triangular protruding connecting blocks. These connecting blocks are provided with screw holes for screw connecting with a speaker. The connecting brackets are in the form of “L” shaped sheets, and are provided on the surface thereof with screw holes. By alignment of the connecting brackets with the indents of the frame, and by screw connecting of the connecting brackets with the frame, the speaker seat can be connected to the wall with screws. Such a structure has the following disadvantages though.

1. Although the frame is provided on the surface thereof with indents as alignment lines, these lines are only spacing lines printed in a simple way, they can not provide good assistance in alignment, but can only be used in relying upon the eyesight of an operator for adjusting; therefore, when in connecting, bevel rather than level state of the frame can be resulted.

2. Connecting of the connecting brackets with the frame is done with locking screws one by one, assembling of the speaker seat can only be accomplished by using a tool; it cannot be assembled and dismantled in a simple and convenient way.

3. In assembling, if the positions of the members are changed, mutual changing among the three kinds of connecting brackets with different lengths are required, these connecting brackets are not common to one another, these members in different styles will increase the cost of production, and can make inconvenience in management for classifying and storage.

In view of these, the inventor of the present invention studied and developed a pre-embedded in-wall speaker seat, with which the frame of the speaker can be fast connected with the brackets without a tool, positioning can be accurate and assembling can be fast.

### SUMMARY OF THE INVENTION

The primary object of the present invention is to provide a pre-embedded in-wall speaker seat that can allow a frame of the speaker to fast connect with a plurality of brackets without a tool but only by engagement of engaging hooks of the brackets with engaging recesses of the frame.

The secondary object of the present invention is to provide a pre-embedded in-wall speaker seat, wherein by providing a plurality of positioning ribs and positioning recesses forming connections of relieves and recesses to accomplish engagement and positioning within the thickness of the wall.

Another object of the present invention is to provide a pre-embedded in-wall speaker seat, wherein by providing a plurality of protrusions on the brackets, the protrusions can contact the engaging grooves to easily make a selection in alignment with the engaging grooves accurately, thereby, an effect of easy adjustment can be obtained.

To achieve the above stated objects, the present invention comprises a frame of the speaker and a plurality of brackets, in which, by insertion of the engaging hooks on the external surfaces of the middle sections of the brackets into the engaging recesses to hook the inner edges of the engaging recesses, the protrusions on the external surfaces of the middle sections of the brackets can be inserted into the engaging grooves in passing to make engagement and positioning of the positioning ribs with the positioning recesses. Thereby, the pre-embedded in-wall speaker seat is completed. By engagement of the brackets with the engaging recesses of the frame of the speaker, the frame of the speaker can be fast connected with the brackets without a tool; and by connecting of the positioning ribs with the positioning recesses as well as the protrusions with the engaging grooves, the brackets can easily get a selection in alignment with the engaging grooves within the thickness of the wall to accomplish engagement and positioning by connections of relieves and recesses.

The present invention will be apparent in its features as well as structure after reading the detailed description of the preferred embodiment thereof in reference to the accompanying drawings.

### BRIEF DESCRIPTION OF THE DRAWINGS

FIGS. 1a-1c are schematic views showing a pre-embedded in-wall speaker seat of a conventional structure;

FIG. 2 is a perspective view of an embodiment of the present invention;

FIG. 3 is an analytical perspective view of the embodiment of the present invention;

FIG. 4 is a perspective view of the embodiment of the present invention in use;

FIG. 5a is a front view of the embodiment of the present invention when in the locking state;

FIG. 5b is a schematic view showing force bearing of the brackets of the embodiment of the present invention;

FIG. 6 is a sectional view showing adjustment for positioning within the thickness of the wall of the embodiment of the present invention.

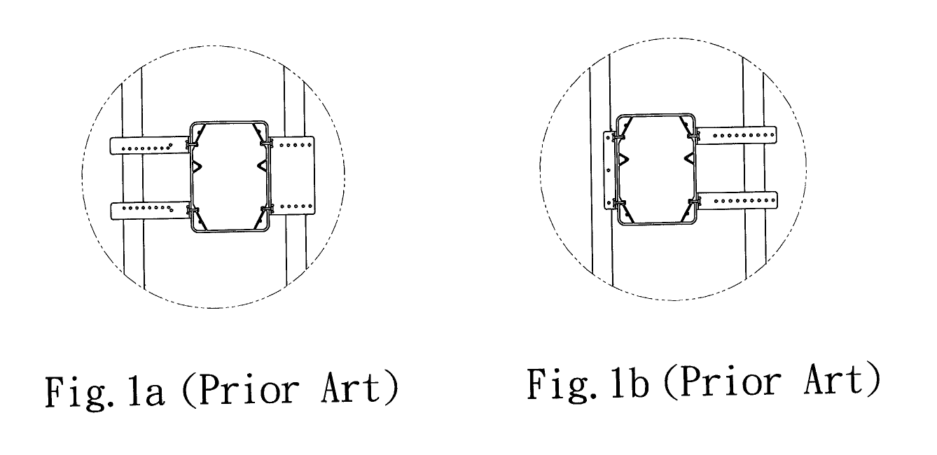

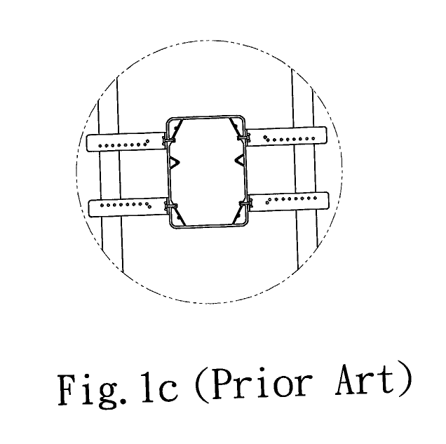

### DETAILED DESCRIPTION OF THE PREFERRED EMBODIMENT

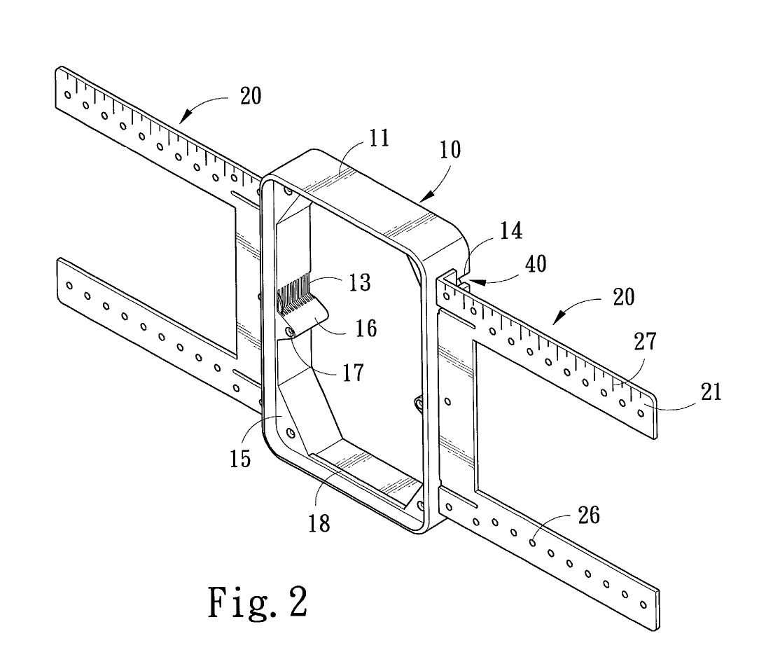

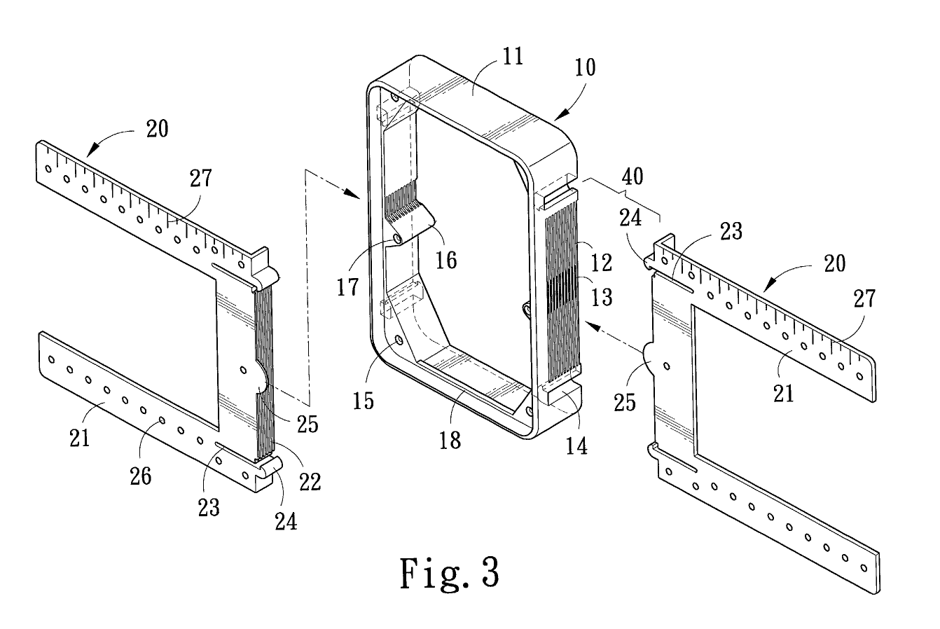

Referring firstly to FIGS. 2 and 3, the pre-embedded in-wall speaker seat of the present invention comprises: a frame 10 of the speaker, a plurality of brackets 20 and means for fixing by engagement 40.

In which, the frame 10 is generally a rectangular frame having external frame walls 11 on the four sides thereof. The external frame walls 11 are provided on the external peripheral surfaces of the lateral two sides thereof with a plurality of elongate positioning recesses 12, and are provided on the corners of the inner surfaces of thereof with a plurality of triangular protruding connecting blocks 15, and are provided on the surfaces of the lateral walls thereof centrally with a plurality of inwardly extending triangular protruding connecting blocks 16. The triangular protruding connecting blocks 15, 16 are provided thereon with a plurality of screw holes 17 for screw connecting with the speaker. The external frame walls 11 are provided at a suitable location thereon with a rib strip 18 to reinforce themselves.

The brackets 20 are generally each in the shape of “␣” and are each provided with two legs 21, and are provided on the external surfaces of the middle sections thereof each with a plurality of positioning ribs 22. The legs 21 of the brackets 20 are provided thereon with a plurality of locking holes 26, to be selected and screw connected onto the posts 30 of a wall panel 31.

The means 40 for fixing by engagement are comprised of male and female parts respectively provided at suitable locations on the frame 10 of the speaker and the brackets 20 to be abutting-connected with each other. A preferred arrangement is that, the frame 10 of the speaker is provided at the two ends of each elongate positioning recess 12 thereof with an engaging recess 14 respectively, and the brackets 20 are provided at the two ends of each positioning rib 22 thereof with two expansion slits 23. The outer ends of the expansion slits 23 each is provided with an engaging hook 24 for hooking in a corresponding engaging recess 14 to make the brackets 20 be hooked on the frame 10.

The present invention can also be provided with auxiliary positioning means for easy connecting, the means include engaging grooves 13 provided on the frame walls 11 and protrusions 25 on the external peripheral surfaces of the middle sections of the brackets 20, thereby when in assembling, the protrusions 25 are inserted into the engaging grooves 13 in the first place to get an effect of capability of selection for positioning.

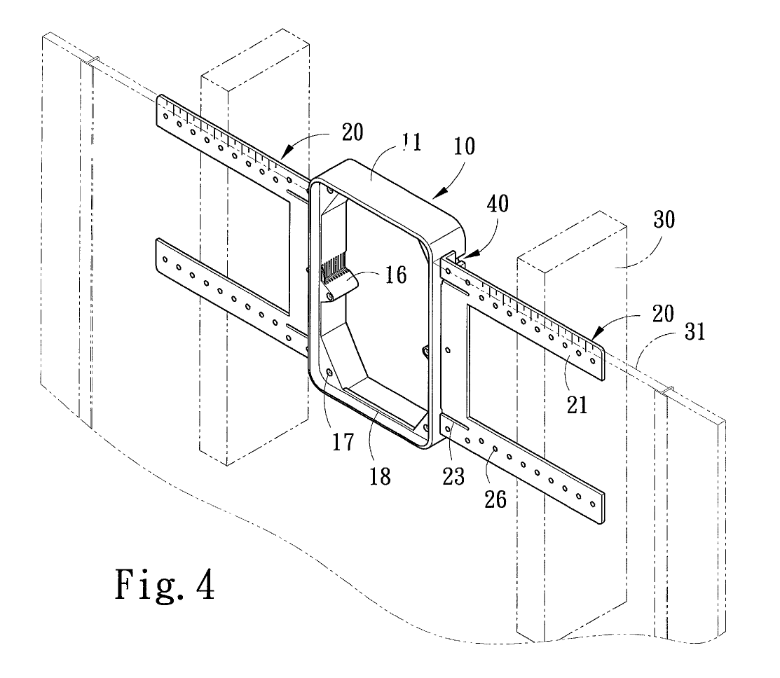

Referring to FIG. 4, when in assembling of the present invention, the protrusions 25 on the external peripheral surfaces of the middle sections of the brackets 20 are used to make a pre-selection for alignment with the engaging grooves 13. By providing the protrusions 25 on the external peripheral surfaces of the middle sections of the brackets 20, the protrusions 25 will be connected the engaging grooves 13 in the first place, thereby can easily and accurately be aligned with and inserted into the engaging grooves 13. And then the engaging hooks 24 on the external peripheral surfaces of the middle sections of the brackets 20 are inserted into the corresponding engaging recesses 14 to hook the inner sides of latter. At this time, the positioning ribs 22 are engaged with the positioning recesses 12. By engagement of the engaging hooks 24 with the engaging recesses 14, the positioning ribs 22 with the positioning recesses 12 and the protrusions 25 with the engaging grooves 13, the brackets 20 are fixed on the frame 10.

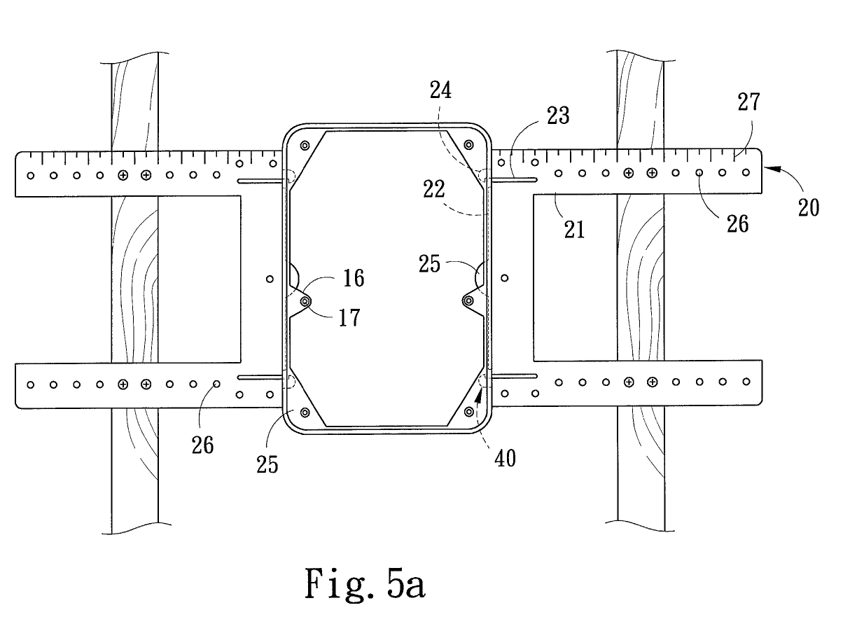

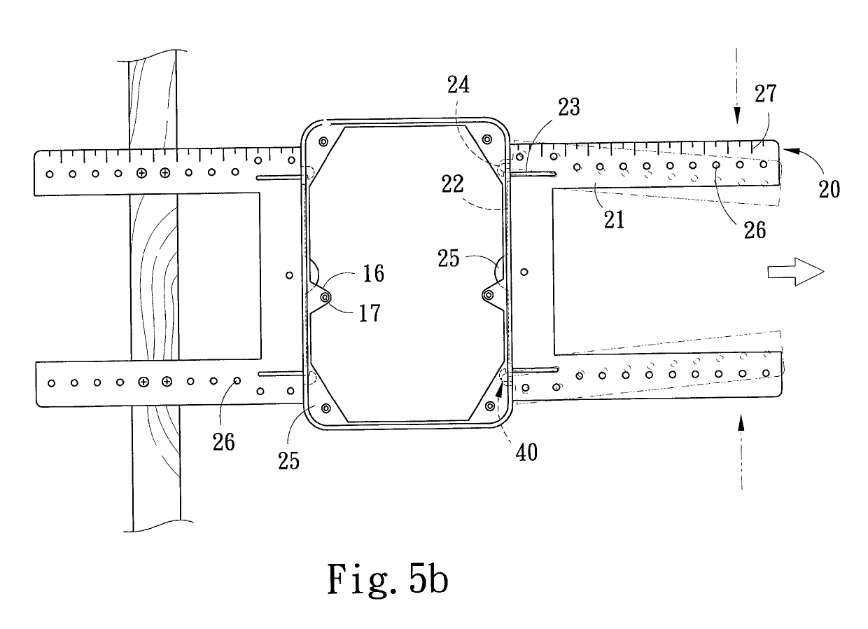

Referring to FIG. 5b, when it is to dismantle before locking of the present invention, just by slightly pressing the legs 21 of the brackets 20 to bend inwardly, the expansion slits 23 provided on the brackets 20 can be moved to open, and the engaging hooks 24 can be moved outwardly at the same time, thereby, the engaging hooks 24 can be easily released from the engaging recesses 14 to allow separation of the brackets 20 from the frame 10.

Referring to FIG. 4 again, when in application, the pre-embedded in-wall speaker seat having been assembled can have the brackets 20 with the locking holes 26 on the legs 21 thereof selected for different lengths required and mounted fixedly by screw connecting on the posts 30. When the wall panel 31 is assembled, the present invention can be hidden in the wall panel 31 ready for installation of the speaker. Referring to FIG. 5a, when the present invention is combined with the posts 30 on the wall panel 31, the legs 21 of the brackets 20 are locked by the screws and thereby can not be bent inwardly, the engaging hooks 24 thereby can firmly hook into the engaging recesses 14 to make firm connection of the brackets 20 with the frame 10. That is to say, when the brackets 20 of the present invention are fixed by screw connecting on the posts 30, the pre-embedded in-wall speaker seat of the present invention not only can be fixed on the posts 30, but also can fix the legs 21 of the brackets 20 to avoid the legs 21 from bending inwardly to make the engaging hooks 24 be released from the engaging recesses 14, thereby the brackets 20 can be combined with the frame 10 firmer.

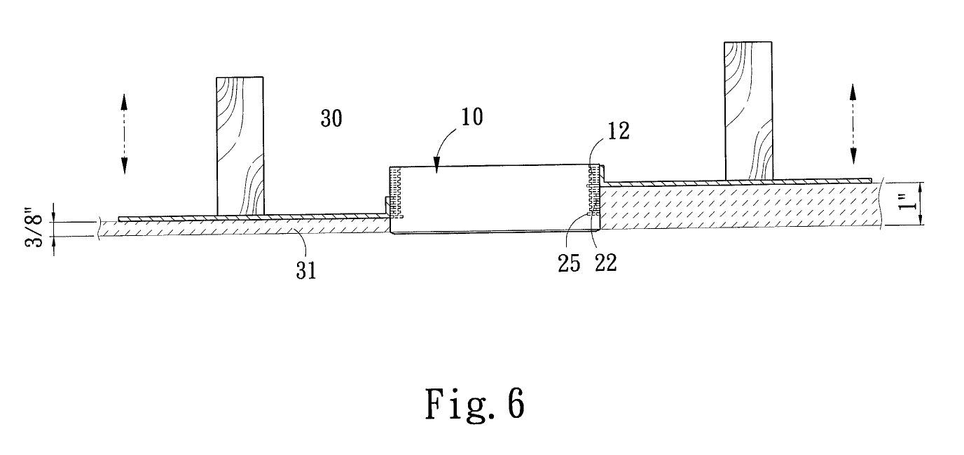

Referring to FIG. 6, the width of the engaging grooves 13 on the frame 10 of the speaker of the present invention is given in pursuance of the specification in re thickness of the wall panel 31, it can be ⅜″, ½″, ⅝″, ¾″ and 1″ etc. in favor of measuring and selection of position; and the legs 21 can be provided thereon with size marks 27 in favor of accurate positioning the frame 10 of the speaker without using a measuring tool. This not only make convenient in use, but also can reduce working hours.

And more, when in assembling the present invention, the positioning recesses 12 of the frame 10 of the speaker can be engaged with the positioning ribs 22 of the brackets 20. This can effectively make positioning at a preset depth of embedment to prevent the frame 10 of the speaker from sliding rearwards, and can further make excellent combination of the frame 10 of the speaker with the brackets 20 by mutual engagement of the positioning ribs 22 with the positioning recesses 12. By providing the engaging grooves 13, the brackets 20 can obtain the insertion position thereof within the thickness of the wall panel 31 to form connections of relieves and recesses to accomplish engagement and positioning. In this way, levelness of the wall surface can be obtained. Therefore, the present invention needs no tool in assembling, and positioning thereof can be accurate and fast, it provides convenience when in use.

Accordingly, the present invention has the following advantages:

1. By engagement of the engaging hooks of the brackets with the engaging recesses of the frame of the present invention, combination of the frame of the speaker with the brackets can be fast; this provides convenience when in use.

2. By providing a plurality of positioning ribs and positioning recesses forming connections of relieves and recesses, the pre-embedded in-wall speaker seat of the present invention can accomplish engagement and positioning within the thickness of the wall; this provides practicality of use.

3. By providing a plurality of protrusions on the brackets, the protrusions can contact the engaging grooves in the first place to easily make a selection in alignment with the required engaging grooves accurately, thereby, an effect of easy adjustment can be obtained; this also provides convenience when in use.

In conclusion, the present invention can get rid of the defects resided in the conventional pre-embedded in-wall speaker seat, but also can make fast combination of the frame of the speaker with the brackets without using a tool to speed up the assembling work. Thereby, practicality and convenience of the present invention can be largely increased, and the present invention can suit various pre-embedded in-wall structures for hi-fis, speakers etc.

The above stated is only for illustrating a preferred embodiment of the present invention, but not for giving any limitation to the scope of the present invention. It will be apparent to those skilled in this art that various equivalent modifications or changes can be made to the elements of the present invention and shall fall within the scope of the appended claims and are intended to form part of this invention.

Having thus described my invention that is doubtlessly industrial valuable, what I claim as new and desire to be secured by Letters Patent of the United States are:

1. A pre-embedded in-wall speaker seat comprising: a frame of a speaker, a plurality of brackets and means for fixing by engagement,
in which said frame is a frame having external frame walls on all the sides thereof, said external frame walls are provided on the external peripheral surfaces of the lateral two sides thereof with a plurality of positioning recesses;
said brackets are each provided with two legs, and are provided on the external peripheral surfaces of the middle sections thereof each with a plurality of positioning ribs to be connected with said positioning recesses on said frame of speaker;
said means for fixing by engagement are comprised of male and female parts respectively provided on said frame of speaker and said brackets to be abutting-connected with each other;
said frame of speaker is connected with said brackets to have said positioning ribs engaged with said positioning recesses, said means for fixing by engagement fixes said brackets to said frame of speaker, thereby said pre-embedded in-wall speaker seat is completed.

2. The pre-embedded in-wall speaker seat as in claim 1, wherein,
said frame of speaker is provided on the corners of the inner surfaces of said external frame walls with a plurality of triangular protruding connecting blocks, and are provided of the surfaces of the lateral walls thereof centrally with a plurality of inwardly extending triangular protruding connecting blocks; said triangular protruding connecting blocks are provided thereon with a plurality of screw holes for screw connecting with the speaker.

3. The pre-embedded in-wall speaker seat as in claim 1, wherein,
said frame of speaker is provided on the inner frame walls thereof with a rib strip to reinforce said walls of said frame.

4. The pre-embedded in-wall speaker seat as in claim 1, wherein, said brackets are each in the shape of “␣” and are provided on said legs with a plurality of locking holes, to be locked onto posts of a wall panel.

5. The pre-embedded in-wall speaker seat as in claim 1, wherein,
said means for fixing by engagement are provided at the two ends of each of said positioning recesses on said external frame walls with an engaging recess respectively, and said brackets are provided at the two ends of each of said positioning ribs thereof with two expansion slits; the outer ends of said expansion slits each is provided with an engaging hook for hooking in a corresponding one of said engaging recesses.

6. The pre-embedded in-wall speaker seat as in claim 1, wherein, said speaker seat is provided with auxiliary positioning means for easy connecting, said means include engaging grooves provided on said frame walls and protrusions on said external peripheral surfaces of said middle sections of said brackets.

7. The pre-embedded in-wall speaker seat as in claim 1, wherein,
said brackets are provided on said legs thereof with size marks.

8. The pre-embedded in-wall speaker seat as in claim 1, wherein, the width of said engaging grooves on said frame of speaker is given in pursuance of the specification in re thickness of said wall panel and thereby is one of the sizes ⅜″, ½″, ⅝″, ¾″ and 1″.
